(19) United States
(12) Patent Application Publication
(10) Pub. No.: US 2024/0192312 A1
(43) Pub. Date: Jun. 13, 2024

(54) DISPLAY DEVICE, COMPUTER PROGRAM, AND SETTING METHOD

(71) Applicant: Sumitomo Electric Industries, Ltd., Osaka (JP)

(72) Inventor: Ryota MORINAKA, Osaka-shi, Osaka (JP)

(73) Assignee: Sumitomo Electric Industries, Ltd., Osaka-shi, Osaka (JP)

(21) Appl. No.: 18/287,889

(22) PCT Filed: Feb. 24, 2022
(86) PCT No.: PCT/JP2022/007583

§ 371 Date: Oct. 23, 2023

(30) Foreign Application Priority Data
Apr. 28, 2021 (JP) 2021-075939

(51) Int. Cl. G01S 7/04; G08G 1/04

(52) U.S. Cl. CPC G01S 7/04; G08G 1/04

(57) ABSTRACT

Provided is a display device including: a display configured to display a setting screen for setting a radio wave radar for infrastructure; and an input unit configured to receive an input of a lane shape line indicating a shape of a lane in a target area, and an input of a mark point indicating a specific position in the target area. The setting screen includes: an image display section configured to display the lane shape line and the mark point so that the lane shape line and the mark point are superimposed on an image obtained by a camera that images the target area; and a coordinate value display section configured to display coordinate values corresponding to the mark point. The coordinate values are coordinate values in a coordinate space of the radio wave radar for infrastructure.

### TECHNICAL FIELD

The present disclosure relates to a display device, a computer program, and a setting method.

This application claims priority on Japanese Patent Application No. 2021-075939 filed on Apr. 28, 2021, the entire content of which is incorporated herein by reference.

### BACKGROUND ART

PATENT LITERATURE 1 discloses an axis adjustment device that performs axis adjustment for an in-vehicle radar mounted in a vehicle.

### CITATION LIST

### Patent Literature

PATENT LITERATURE 1: Japanese Laid-Open Patent Publication No. 2015-68746

### SUMMARY OF THE INVENTION

A display device according to one aspect of the present disclosure is a display device including: a display unit configured to display a setting screen for setting a radio wave radar for infrastructure, the radio wave radar being configured to transmit a radio wave to a target area, and receive a reflected wave from a vehicle to detect the vehicle in the target area; and an input unit configured to receive an input of a lane shape line indicating a shape of a lane in the target area, and an input of a mark point indicating a specific position in the target area. The setting screen includes: an image display section configured to display the lane shape line and the mark point inputted through the input unit so that the lane shape line and the mark point are superimposed on an image obtained by a camera that images the target area; and a coordinate value display section configured to display coordinate values corresponding to the mark point. The coordinate values are coordinate values, in a coordinate space, which indicate a position of an object detected by the radio wave radar for infrastructure.

A computer program according to one aspect of the present disclosure is a computer program for causing a computer to perform the steps of: displaying a setting screen for setting a radio wave radar for infrastructure, the radio wave radar being configured to transmit a radio wave to a target area, and receive a reflected wave from a vehicle to detect the vehicle in the target area; and receiving an input of a lane shape line indicating a shape of a lane in the target area, and an input of a mark point indicating a specific position in the target area. The setting screen includes: an image display section configured to display the lane shape line and the mark point inputted through an input unit so that the lane shape line and the mark point are superimposed on an image obtained by a camera that images the target area; and a coordinate value display section configured to display coordinate values corresponding to the mark point. The coordinate values are coordinate values, in a coordinate space, which indicate a position of an object detected by the radio wave radar for infrastructure.

A setting method according to one aspect of the present disclosure is a setting method using, in combination, a radio wave radar for infrastructure and a camera, the radio wave radar being configured to transmit a radio wave to a target area and receive a reflected wave from a vehicle to detect the vehicle in the target area, the camera being configured to enable optical expression of a field of view of the radio wave radar for infrastructure. The method includes: determining a mark point that indicates a specific position included in the target area, displaying the mark point and a lane shape line that indicates a shape of a lane included in the target area so that the mark point and the lane shape line are superimposed on an image obtained by the camera; and setting coordinates indicating the position of the mark point.

The present disclosure can be realized not only as a display device including such a characteristic configuration described above but also as a setting method including such characteristic process steps as described above, or as a computer program for causing a computer to perform the above method. The present disclosure can be realized as an installation angle adjustment system for a radar including a display device, or a part or the entirety of the display device can be realized as a semiconductor integrated circuit.

### BRIEF DESCRIPTION OF DRAWINGS

FIG. 1 shows a usage example of a radio wave radar for infrastructure according to a first embodiment.

FIG. 2 is a perspective view showing an example of an external configuration of the radio wave radar for infrastructure according to the first embodiment.

FIG. 3 is a block diagram showing an example of a configuration of a radar setting device according to the first embodiment.

FIG. 4 is a functional block diagram showing an example of a function of the radar setting device according to the first embodiment.

FIG. 5A shows an example of a setting screen according to the first embodiment.

FIG. 5B shows an example of the setting screen with basic data being inputted.

FIG. 5C shows an example of the setting screen with a lane shape line being drawn.

FIG. 5D shows an example of the setting screen with mark points being inputted.

FIG. 5E shows an example of the setting screen in a lane area edit mode.

FIG. 5F shows an example of the setting screen with a travel locus of a vehicle being displayed.

FIG. 5G shows an example of the setting screen after the position and angle of the travel locus are adjusted.

FIG. 5H shows an example of the setting screen on which the number of vehicles per lane detected by the radio wave radar for infrastructure and the number of vehicles per lane inputted by users are displayed.

FIG. 6A illustrates an example of initial setting of lane areas in a radar coordinate space.

FIG. 6B illustrates an example of setting of lane areas in the radar coordinate space.

FIG. 7 shows an example of a save instruction section.

FIG. 8 is a flowchart showing an example of a procedure of a lane area setting process of the radar setting device according to the first embodiment.

FIG. 9 shows an example of a selection section.

### DETAILED DESCRIPTION

### Problems to be Solved by the Present Disclosure

Radars are also used for traffic monitoring at intersections, roads, and the like. A radar for traffic monitoring (radio wave radar for infrastructure), for example, detects the positions of traveling vehicles for each lane, and counts the number of vehicles for each lane. In order for the radio wave radar for infrastructure to accurately detect vehicles, the relationship between a coordinate space in the radio wave radar for infrastructure and the position of the road must be correctly set in the radio wave radar for infrastructure. Since the configurations of roads, such as the number of lanes, the shape of lanes, etc., vary from road to road, it is difficult to set the relationship between the coordinate space and the position of the road in the radio wave radar for infrastructure.

### Effects of the Present Disclosure

According to the present disclosure, it is possible to support setting of the relationship between the coordinate space and the position of the road in the radio wave radar for infrastructure.

### DESCRIPTION OF EMBODIMENT OF THE PRESENT DISCLOSURE

Hereinafter, the outlines of embodiments of the present invention will be listed and described.
(1) A display device according to an embodiment of the present disclosure is a display device including: a display unit configured to display a setting screen for setting a radio wave radar for infrastructure, the radio wave radar being configured to transmit a radio wave to a target area, and receive a reflected wave from a vehicle to detect the vehicle in the target area: and an input unit configured to receive an input of a lane shape line indicating a shape of a lane in the target area, and an input of a mark point indicating a specific position in the target area. The setting screen includes: an image display section configured to display the lane shape line and the mark point inputted through the input unit so that the lane shape line and the mark point are superimposed on an image obtained by a camera that images the target area; and a coordinate value display section configured to display coordinate values corresponding to the mark point. The coordinate values are coordinate values, in a coordinate space, which indicate a position of an object detected by the radio wave radar for infrastructure. This configuration allows the user to input, to the setting screen, the lane shape line and the mark point that are used for defining the relationship between the coordinate space and the position of a road in the radio wave radar for infrastructure, whereby setting of the relationship between the coordinate space and the position of the road in the radio wave radar for infrastructure can be supported.
(2) The display device may further include an output unit configured to output setting information for setting the position and shape of a lane in the coordinate space, based on the lane shape line and the mark point received through the input unit and on the coordinate values. Thus, the position and shape of the lane in the coordinate space of the radio wave radar for infrastructure can be set by using the outputted setting information.
(3) The setting screen may further include an input instruction portion configured to receive an instruction to input the mark point. When the instruction to input the mark point has been received by the input instruction portion, input of the mark point on the image may be allowed. After instructing input of the mark point by using the input instruction portion, the user can directly input the mark point on the image. Thus, input of the mark point by the user can be supported.
(4) The coordinate value display section may receive the coordinate values inputted through the input unit, and may display the received coordinate values. Thus, input of the coordinate values of the mark point in the coordinate space of the radio wave radar for infrastructure can be supported.
(5) The image display section may display, on the image, selectable candidate points that are candidates for the mark point, and a candidate point selected through the input unit may be set as the mark point. This configuration allows the user to easily input the mark point by selecting a candidate point. Therefore, input of the mark point by the user can be supported.
(6) The image display section may display a movement locus of the object detected by the radio wave radar for infrastructure so that the movement locus is superimposed on the image. The user can easily confirm whether or not the relationship between the coordinate space and the position of the lane in the radio wave radar for infrastructure is correctly set by confirming whether or not the movement locus fits in the lane in the image.
(7) The setting screen may further include an adjustment portion configured to receive adjustment of the position of the movement locus with respect to the image. The display device may include an output unit configured to, based on the adjustment of the position of the movement locus, output correction information for correcting the position and the shape of the lane in the coordinate space. Thus, the relationship between the coordinate space and the position of the lane can be corrected by adjusting the position of the movement locus in the image.
(8) The position of the movement locus may be changed with respect to the image, based on the adjustment of the position of the movement locus. Thus, the user can adjust the position of the movement locus while confirming the position of the movement locus with respect to the image. Therefore, adjustment of the position of the movement locus by the user can be supported.
(9) The radio wave radar for infrastructure may include a fixing member that fixes the camera, with an optical axis direction of the camera being aligned with an axial direction of a radio wave irradiation axis of the radio wave radar for infrastructure. Thus, when the radio wave irradiation axis of the radio wave radar for infrastructure is aligned to the target area, the camera can capture the image of the target area.
(10) A computer program according to the embodiment is a computer program for causing a computer to perform the steps of: displaying a setting screen for setting a radio wave radar for infrastructure, the radio wave radar being configured to transmit a radio wave to a target area, and receive a reflected wave from a vehicle to detect the vehicle in the target area; and receiving an input of a lane shape line indicating a shape of a lane in the target area, and an input of a mark point indicating a specific position in the target area. The setting screen includes: an image display section configured to display the lane shape line and the mark point inputted through an input unit so that the lane shape line and the mark point are superimposed on an image obtained by a camera that images the target area; and a coordinate value display section configured to display coordinate values corresponding to the mark point. The coordinate values are coordinate values, in a coordinate space, which indicate a position of an object detected by the radio wave radar for infrastructure. This configuration allows the user to input, to the setting screen, the lane shape line and the mark point that are used for defining the relationship between the coordinate space and the position of a road in the radio wave radar for infrastructure, whereby setting of the relationship between the coordinate space and the position of the road in the radio wave radar for infrastructure can be supported.
(11) A setting method according to the embodiment is a setting method using, in combination, a radio wave radar for infrastructure and a camera, the radio wave radar being configured to transmit a radio wave to a target area and receive a reflected wave from a vehicle to detect the vehicle in the target area, the camera being configured to enable optical expression of a field of view of the radio wave radar for infrastructure. The method includes: determining a mark point that indicates a specific position included in the target area; displaying the mark point and a lane shape line that indicates a shape of a lane included in the target area so that the mark point and the lane shape line are superimposed on an image obtained by the camera; and setting coordinates indicating the position of the mark point. Thus, the lane shape line and the mark point, which are used for defining the relationship between the coordinate space and the position of a road in the radio wave radar for infrastructure, can be displayed so as to be superimposed on the image obtained by the camera, whereby setting of the relationship between the coordinate space and the position of the road in the radio wave radar for infrastructure can be supported.

### DETAILS OF EMBODIMENT OF THE PRESENT DISCLOSURE

Hereinafter, details of embodiments of the present disclosure will be described with reference to the drawings. At least some of embodiments described below may be combined as desired.

### 1. First Embodiment

### [1-1. Radar]

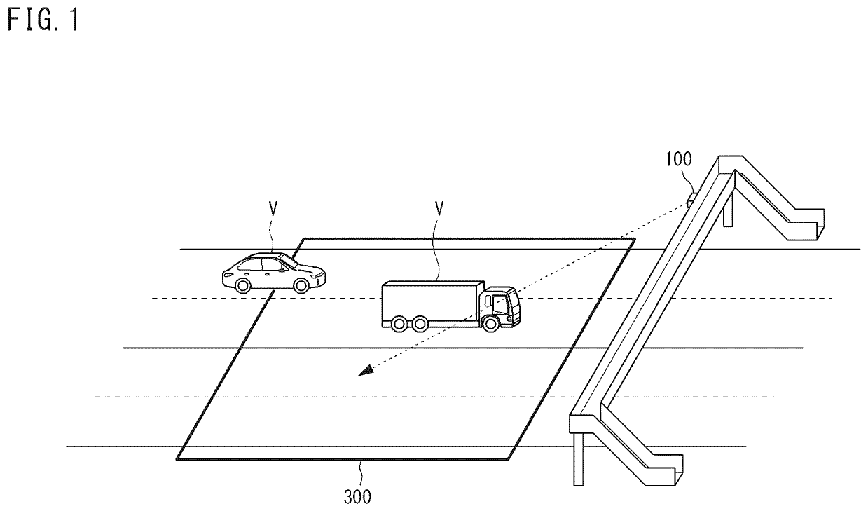

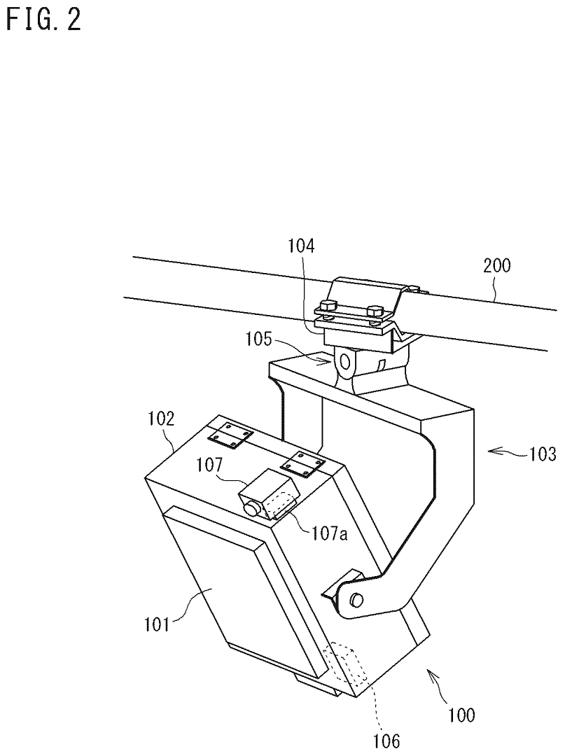

FIG. 1 shows a usage example of a radar according to a first embodiment. A radar 100 according to the present embodiment is a radio wave radar for traffic monitoring (radio wave radar for infrastructure). The radar 100 is mounted to an arm 200 (see FIG. 2) or the like provided at an intersection or a road. The radar 100 is a millimeter wave radar, and a radio wave sensor. The radar 100 irradiates a target area 300 of the road with a radio wave (millimeter wave) and receives the reflected wave to detect an object (e.g., vehicle V) in the target area 300. More specifically, the radar 100 can detect the distance to a vehicle V traveling on the road, the speed of the vehicle V, and the horizontal angle of the position of the vehicle V with respect to a radio wave irradiation axis of the radar.

The radar 100 is installed such that the direction of the radio wave irradiation axis (direction indicated by a broken line in FIG. 1; hereinafter referred to as “reference direction”) faces the target area 300. Unless the reference direction correctly faces the target area 300, the object in the target area 300 cannot be accurately detected by the radar 100. Therefore, the angle of the radar 100 is adjusted so that the reference direction faces the target area 300.

FIG. 2 is a perspective view showing an external configuration of the radar 100 according to the first embodiment. As shown in FIG. 2, the radar 100 has a transmission/reception surface 101 for transmitting/receiving a millimeter wave. The reference direction is a normal direction of the transmission/reception surface 101. The radar 100 houses at least one transmission antenna and a plurality of (e.g., two) reception antennae (not shown). The radar 100 transmits a modulated wave as a millimeter wave from the transmission antenna through the transmission/reception surface 101. The modulated wave hits the object and is reflected, and the reception antenna receives the reflected wave. The radar 100 subjects a transmitted wave signal and a received wave signal to signal processing by using a signal processing circuit (not shown), and detects the distance to the object, the angle at which the object is present (hereinafter referred to as “object position”), and the speed of the object.

The radar 100 has an adjustable installation angle. The radar 100 includes a radar body 102, a depression angle adjustment member 103, a horizontal angle adjustment member 104, and a roll angle adjustment member 105. The radar body 102 is formed in a box shape, and the depression angle adjustment member 103 is mounted to a side surface of the radar body 102. The depression angle adjustment member 103 allows the radar body 102 to turn around a horizontal shaft, thereby adjusting the depression angle of the radar body 102. The radar body 102 is connected to the roll angle adjustment member 105 via the depression angle adjustment member 103, and the roll angle adjustment member 105 allows the radar body 102 to turn left and right with respect to the transmission/reception surface 101, thereby adjusting the roll angle of the radar body 102. The horizontal angle adjustment member 104 is fixed to a pole as an installation target. The radar body 102 is connected to the horizontal angle adjustment member 104 via the depression angle adjustment member 103 and the roll angle adjustment member 105, and the horizontal angle adjustment member 104 allows the radar body 102 to turn around a vertical shaft, thereby adjusting the horizontal angle of the radar body 102.

The radar 100 detects a vehicle V for each lane. The radar 100 specifies coordinates of a detected vehicle V in a coordinate space that is set in advance. In the coordinate space, an area of each lane is set, and a lane on which a vehicle V travels is specified depending on which area the coordinates of the vehicle V are present. The radar body 102 houses a storage unit 106 being a nonvolatile memory, for example, and setting information of lanes in the coordinate space is stored in the storage unit 106.

As shown in FIG. 2, a camera 107 is mounted to the radar body 102. A fixing member 107a for fixing the camera 107 is disposed on an upper surface of the radar body 107. The fixing member 107a allows the camera 107 mounted thereto to be fixed to the radar body 102. The fixing member 107a allows the optical axis of the camera 107 to be parallel to the radio wave irradiation axis of the radar 100. That is, the camera 107 being fixed by the fixing member 107a allows the optical axis of the camera 107 to face in the reference direction. Thus, the camera 107 can capture an image of the target area.

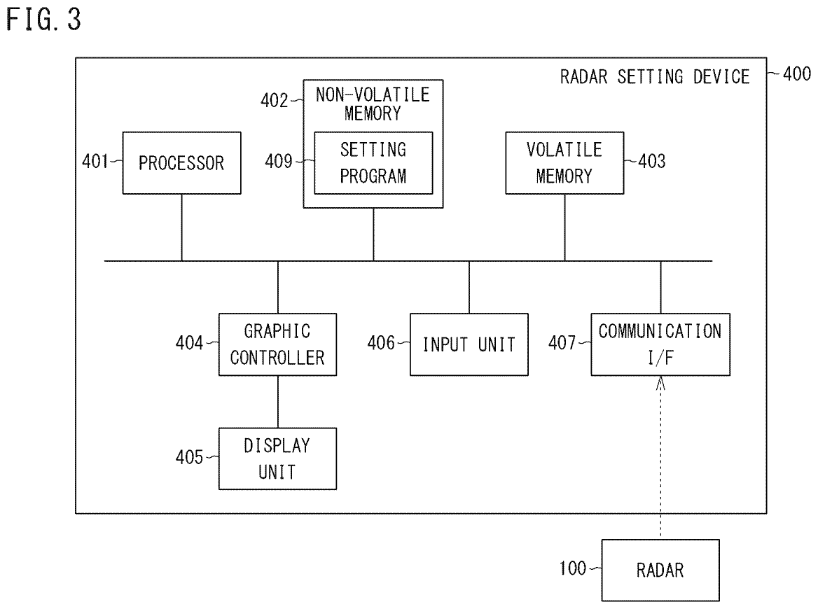

The radar body 102 includes a communication unit (not shown). As shown in FIG. 3, the radar 100 is connected to the radar setting device 400 via the communication unit, wirelessly or through a wire. The radar setting device 400 is used for setting an area of a lane in the coordinate space of the radar 100. An image captured by the camera 107 (hereinafter, referred to as “camera image”) is transmitted to the radar setting device 400. Information about vehicles V (the positions of the vehicles V, the lanes on which the vehicles V are traveling, the number of vehicles V detected for each lane, etc.) detected by the radar 100 is transmitted to the radar setting device 400. The radar setting device 400 can transmit setting information of areas of lanes in the coordinate space of the radar 100. The transmitted setting information is stored in the storage unit 106, whereby the setting information is updated.

### [1-2. Configuration of Radar Setting Device]

FIG. 3 is a block diagram showing an example of the configuration of the radar setting device according to the first embodiment. The radar setting device 400 is an example of a display device. The radar setting device 400 is configured as a portable information terminal device such as a smart phone, a tablet, or a portable computer. The radar setting device 400 includes a processor 401, a non-volatile memory 402, a volatile memory 403, a graphic controller 404, a display unit 405, an input unit 406, and a communication interface (communication I/F) 407.

The volatile memory 403 is, for example, a semiconductor memory such as a SRAM (Static Random Access Memory) or a DRAM (Dynamic Random Access Memory). The non-volatile memory 402 is, for example, a flash memory, a hard disk, a ROM (Read Only Memory), or the like. The non-volatile memory 402 has, stored therein, a setting program 409 as a computer program, and data to be used for execution of the setting program 409. The radar setting device 400 is configured to include a computer, and functions of the radar setting device 400 are exhibited by the processor 401 executing the setting program 409 which is a computer program stored in a storage device of the computer. The setting program 409 can be stored in a storage medium such as a flash memory, a ROM, or a CD-ROM. The processor 401 executes the setting program 409, and causes the display unit 405 to display a setting screen as described later.

The processor 401 is a CPU (Central Processing Unit), for example. However, the processor 401 is not limited to a CPU. The processor 401 may be a GPU (Graphics Processing Unit). The processor 401 may be, for example, an ASIC (Application Specific Integrated Circuit), or a programmable logic device such as a gate array or an FPGA (Field Programmable Gate Array). In this case, the ASIC or the programmable logic device is configured to be able to execute the same processing as that of the setting program 409.

The graphic controller 404 is connected to the display unit 405, and controls display on the display unit 405. The graphic controller 404 includes, for example, a GPU and a VRAM (Video RAM), holds data, in the VRAM, to be displayed on the display unit 405, and periodically reads video data per frame from the VRAM to generate a video signal. The generated video signal is outputted to the display unit 405, and an image is displayed on the display unit 405. The function of the graphic controller 404 may be included in the processor 401. A partial area of the volatile memory 403 may be used as a VRAM.

The display unit 405 includes a liquid crystal panel, or an OEL (organic electro luminescence) panel, for example. The display unit 405 can display information of characters or graphics. The input unit 406 includes, for example, a capacitance type or pressure-sensitive type touch pad superimposed on the display unit 405. The input unit 406 may be a pointing device such as a keyboard or a mouse. The input unit 406 is used for inputting information to the radar setting device 400.

The communication I/F 407 can communicate with external devices wirelessly or via wires. The communication I/F 407 can receive a camera image outputted from the camera 107. The communication I/F 407 can receive information about vehicles V detected by the radar 100. The communication I/F 407 can transmit, to the radar 100, setting information of areas of lanes in the coordinate space of the radar 100.

### [1-3. Function of Radar Setting Device]

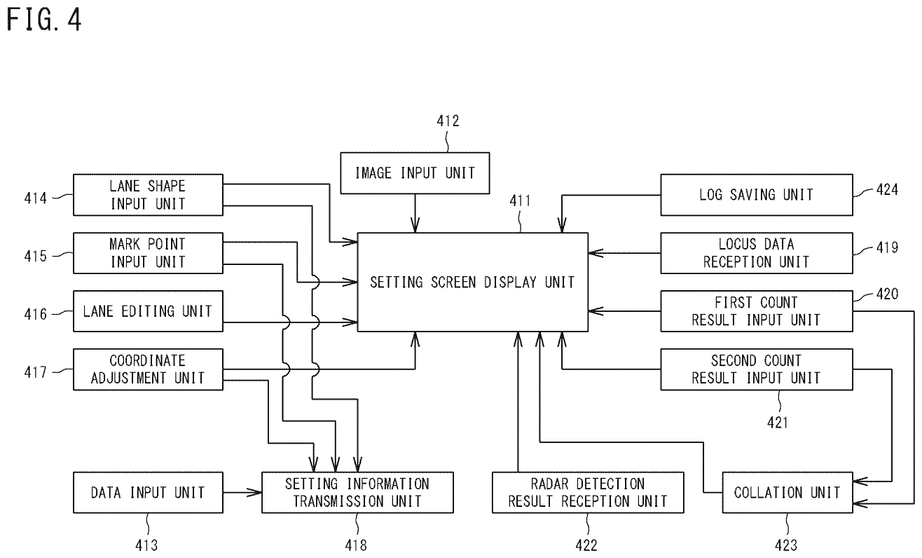

FIG. 4 is a functional block diagram showing an example of functions of the radar setting device 400 according to the first embodiment. The setting program 409 being executed by the processor 401 allows the radar setting device 400 to function as a setting screen display unit 411, an image input unit 412, a data input unit 413, a lane shape input unit 414, a mark point input unit 415, a lane editing unit 416, a coordinate adjustment unit 417, a setting information transmission unit 418, a locus data reception unit 419, a first count result input unit 420, a second count result input unit 421, a radar detection result reception unit 422, a collation unit 423, and a log saving unit 424.

The setting screen display unit 411 is realized by the display unit 405. The setting screen display unit 411 can display a setting screen. The setting screen is a screen for setting lane areas in the coordinate space of the radar 100 (hereinafter referred to as “lane area setting”).

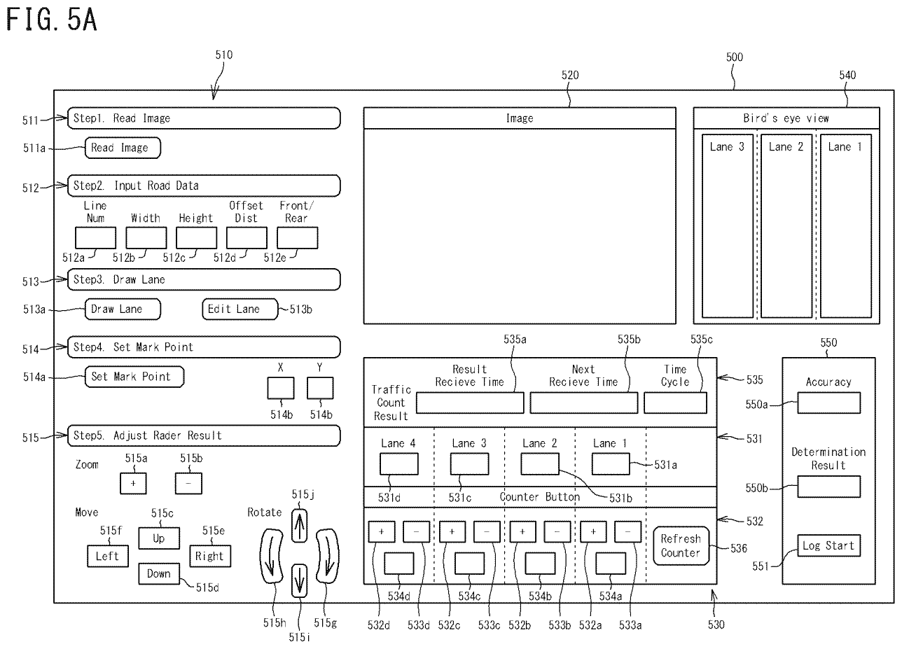

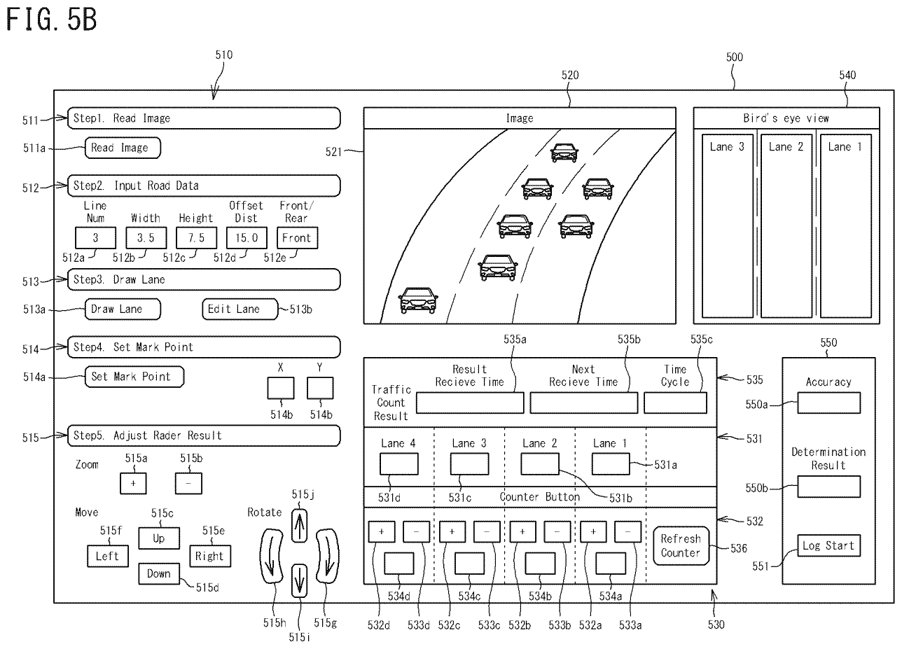

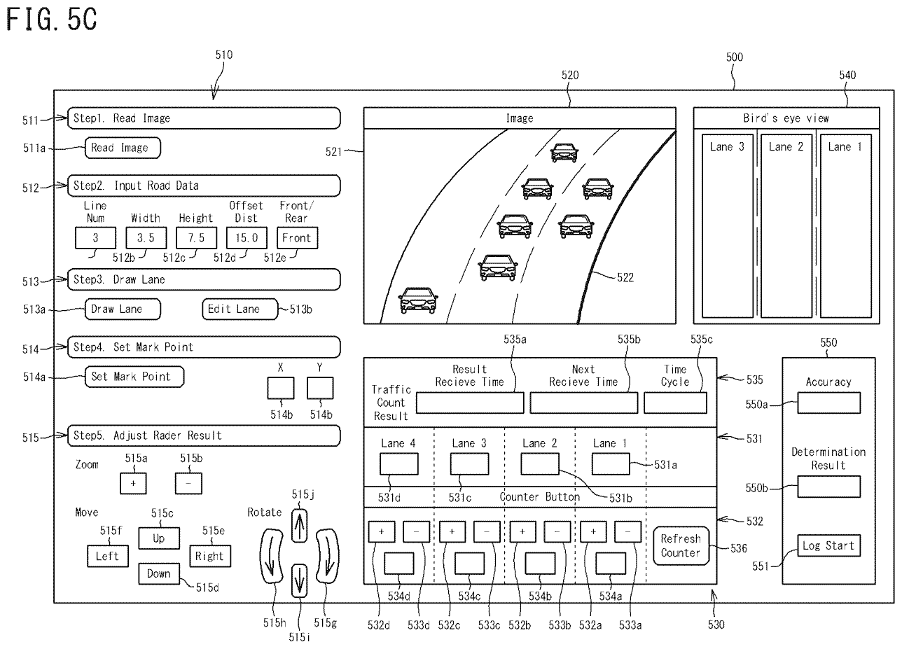

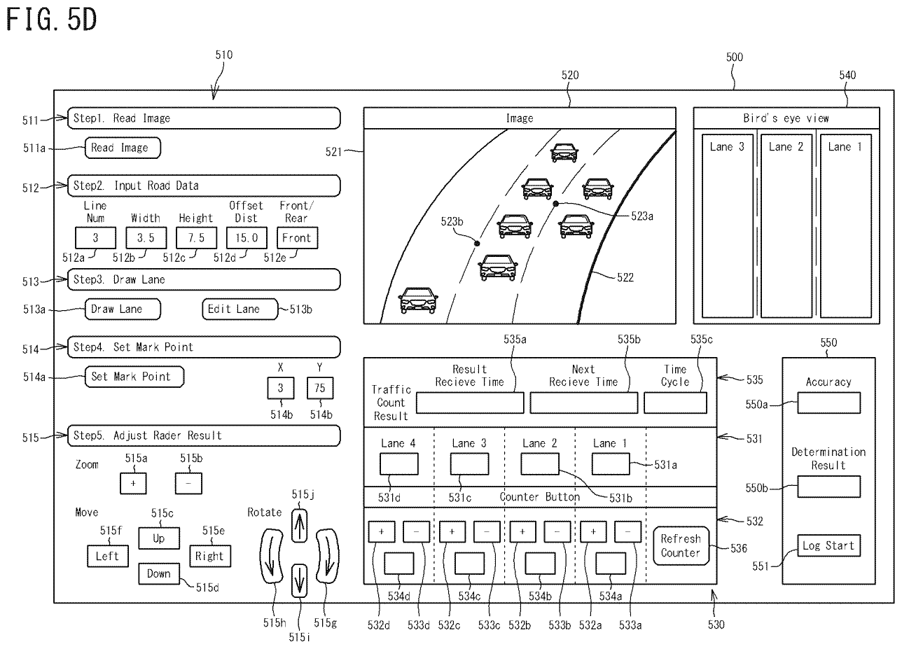

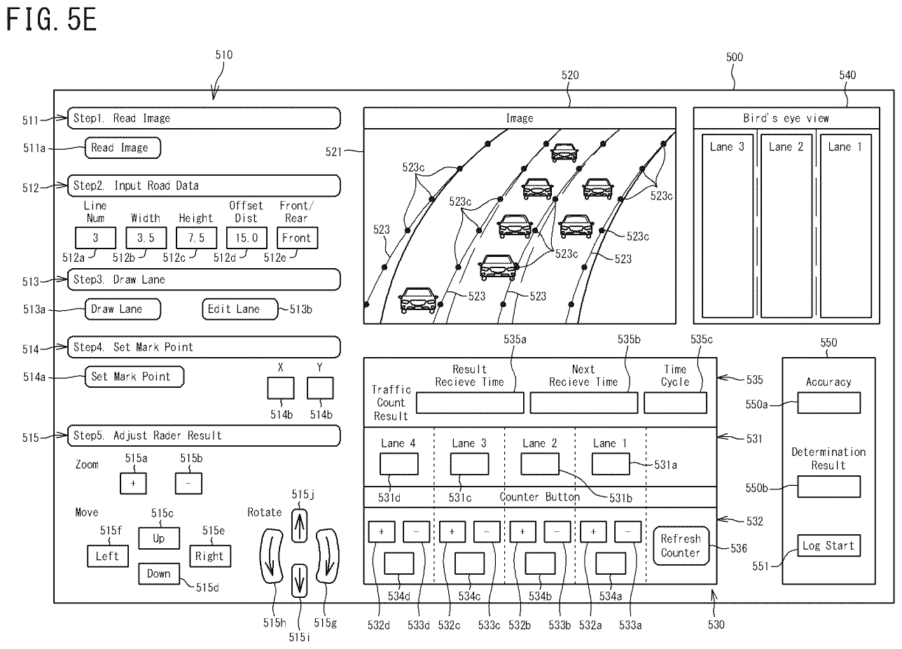

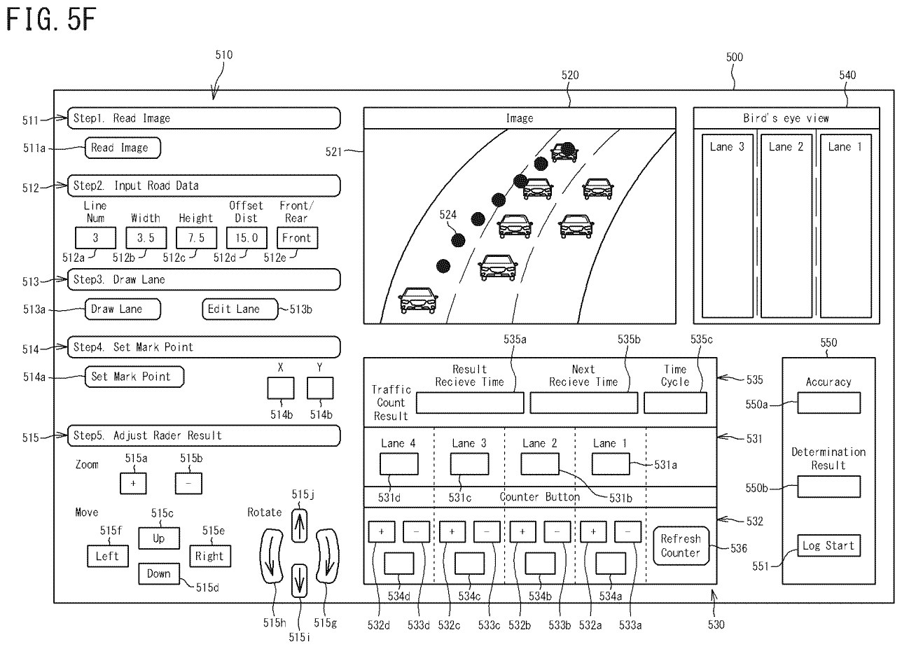

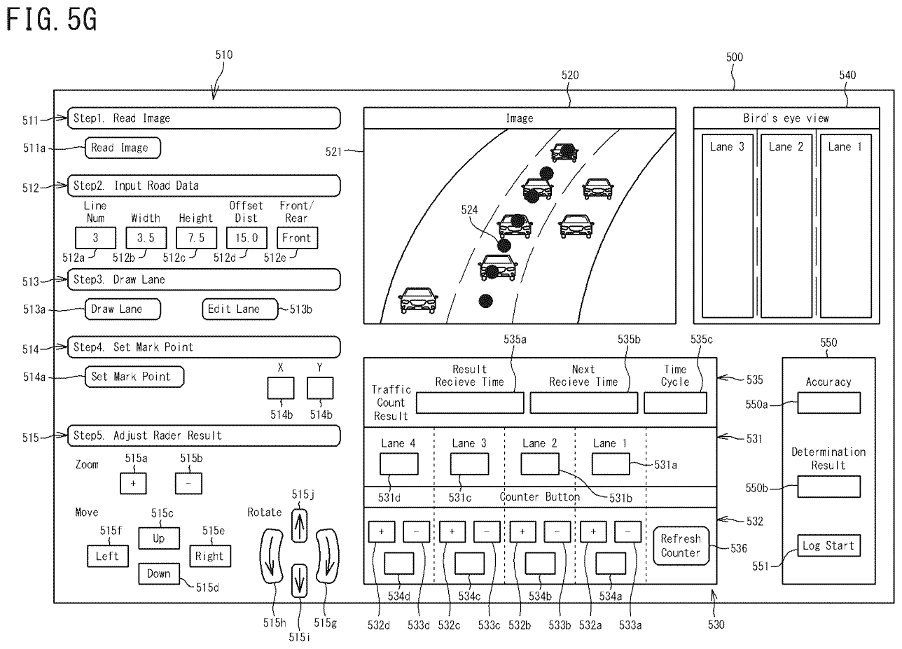

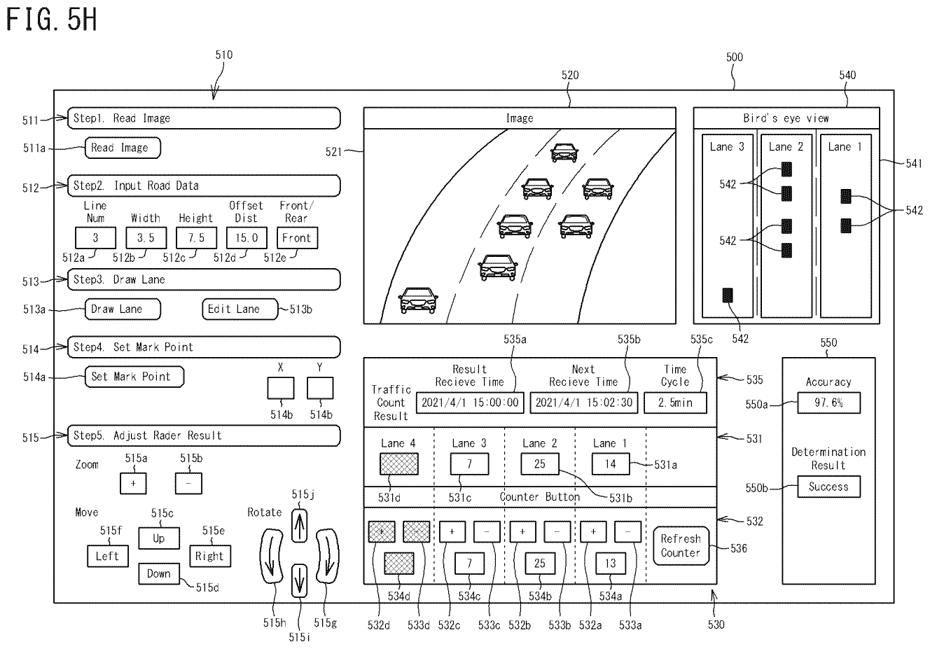

FIG. 5A shows an example of a setting screen according to the first embodiment. A setting screen 500 is a screen for setting the radar 100. As shown in FIG. 5A, the setting screen 500 includes a user operation section 510, an image display section 520, a traffic count result display section 530, and a bird's eye view display section 540.

The user operation section 510 is an area that receives an operation of the user. The user can input various information to the radar setting device 400 by operating the user operation section 510. The user operation section 510 includes an image reading instruction portion 511, a basic data input portion 512, a lane drawing instruction portion 513, a mark point input instruction portion 514, and a lane adjustment portion 515.

The image reading instruction portion 511 includes an image read button 511a. The image read button 511a is a button for instructing the radar setting device 400 to read a camera image outputted from the camera 107. The image display section 520 is an area for displaying the read camera image.

Refer to FIG. 4 again. When the user selects the image read button 511a, the image input unit 412 receives an input of the camera image outputted from the radar 100. The setting screen display unit 411 displays the inputted camera image on the image display section 520. The camera image may be a still image or a moving image. If the number of vehicles is counted by using the camera image as described later, the camera image is preferably a moving image. In order to count the number of vehicles, a plurality of still images may be displayed in the chronological order of image capturing. When the camera image is a moving image or a plurality of still images, image reading is continuously performed. This allows the camera image to be displayed in real time on the image display section 520.

Refer to FIG. 5A again. The basic data input portion 512 is used for inputting basic data for lane area setting, such as the number of lanes in the target area 300, the lane width, the installation height of the radar 100, the offset amount, and the vehicle detection method (hereinafter collectively referred to as “basic data”). The basic data is used for setting a coordinate system of the radar 100, initial setting of lane areas in the coordinate space, and the like. The basic data input portion 512 includes a number-of-lanes input portion 512a, a lane width input portion 512b, an installation height input portion 512c, an offset amount input portion 512d, and a detection method input portion 512e. The number-of-lanes input portion 512a is an input box, and is used for inputting the number of lanes in the target area 300. The lane width input portion 512b is an input box, and is used for inputting the lane width. The installation height input portion 512c is an input box, and is used for inputting the installation height of the radar 100 from the ground surface. The offset amount input portion 512d is an input box, and is used for inputting the offset amount from the origin of the mounting position of the radar 100 with respect to the road width direction. The origin is set, for example, at the left end of the road when viewed from the mounting position of the radar 100. The detection method input portion 512e is a selection box. For example, when the detection method input portion 512e is selected, a dropdown menu is displayed. The dropdown menu includes two items; vehicle front measurement (method for detecting a vehicle from its head); and vehicle tail measurement (method for detecting a vehicle from its tail). The detection method input portion 512e is used for selecting one of the vehicle head measurement and the vehicle tail measurement.

FIG. 5B shows an example of the setting screen with the basic data inputted. In FIG. 5B, the number of lanes “3” is inputted to the number-of-lanes input portion 512a, the lane width “3.5” is inputted to the lane width input portion 512b, the installation height “7.5” is inputted to the installation height input portion 512c, the offset amount “15.0” is inputted to the offset amount input portion 512d, and “Front” indicating the vehicle head measurement is designated in the detection method input portion 512e.

Refer to FIG. 4 again. The data input unit 413 receives the basic data that the user has inputted to the basic data input portion 512. The setting information transmission unit 418 transmits the basic data received by the data input unit 413, to the radar 100.

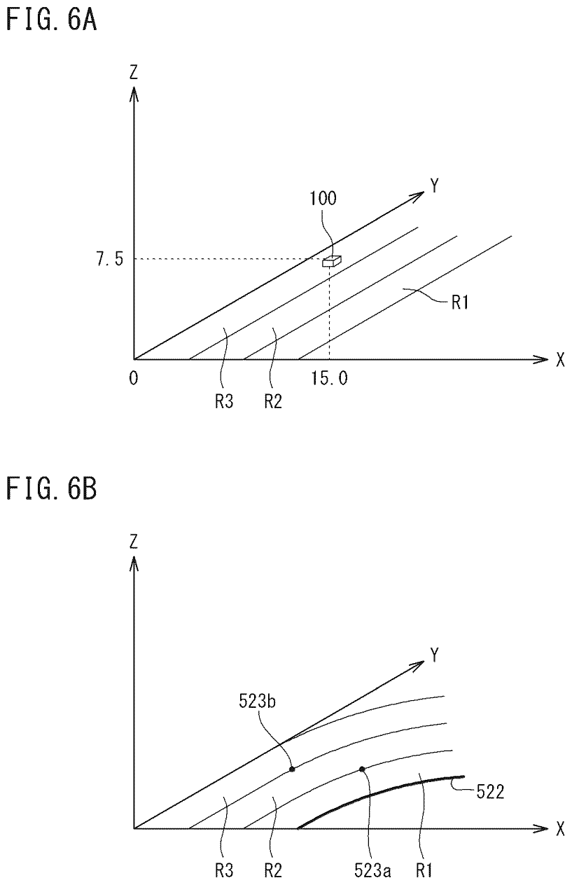

The radar 100 sets a coordinate system based on the received basic data, and initially sets lane areas in the coordinate space. FIG. 6A illustrates an example of initial setting of lane areas in the coordinate space of the radar. The radar 100 sets, for example, an origin of coordinates and a coordinate position of the radar 100, based on the offset amount and the installation height. For example, a coordinate system having an X axis extending in the road length direction, a Y axis extending in the road width direction, and a Z axis extending in the vertical direction, is set. In FIG. 6A, an origin O and a coordinate position of the radar 100 are set based on the offset amount “15.0” and the installation height “7.5”. Moreover, the radar 100 sets lane areas, based on the number of lanes and the lane width. In FIG. 6A, lane areas R1, R2, R3 are set in the coordinate space, based on the number of lanes “3” and the lane width “3.5”. For example, the lanes are linear in the initial setting.

Refer to FIG. 5A again. The lane drawing instruction portion 513 includes a lane drawing instruction button 513a, and a lane edit button 513b. The lane drawing instruction button 513a is a button for instructing the start of inputting a line indicating the shape of a lane (hereinafter referred to as “lane shape line”) in the target area 300. When the lane drawing instruction button 513a is selected, drawing of a line (straight line or curved line) is allowed in the image display section 520. FIG. 5C shows an example of the setting screen with a lane shape line being drawn. As shown in FIG. 5C, the user can draw a lane shape line superimposed on the image of the road displayed in the image display section 520. For example, if the input unit 406 is a touch pad, the user can draw a lane shape line 522 by tracing, with a finger or a stylus, a lane marking line such as a center line or a lane boundary line on the road in the camera image 521 displayed on the image display section 520.

The lane edit button 513b is a button for instructing the start of editing of the set lane area. When the lane edit button 513b is selected, the setting screen shifts to an edit mode, and editing of the lane area set in the radar 100 is allowed. Editing of the lane area will be described later.

Refer to FIG. 4 again. The lane shape input unit 414 receives the lane shape line 522 that the user has drawn on the camera image 521 through selection of the lane drawing instruction button 513a, and receives the lane shape line 522 that the user has edited through selection of the lane edit button 513b.

Refer to FIG. 5A again. The mark point input instruction portion 514 includes a mark point input button 514a and a coordinate value input portion 514b. The mark point input button 514a is a button for inputting a mark point to the camera image 521 displayed on the image display section 520. The mark point is a point indicating a specific position in the target area 300. The coordinate value input portion 514b is an example of a coordinate value display section that displays coordinate values corresponding to the specific position indicated by the mark point. The coordinate value input portion 514b is an input box, and is used for inputting coordinate values of the mark point. The coordinate value input portion 514b receives the coordinate values inputted by using the input unit 406, and displays the received coordinate values. FIG. 5D shows an example of the setting screen with mark points being inputted. Since the mark point is a position on the road, the Z value is “0”. The user can input the X value and the Y value of the mark point to the coordinate value input portion 514b. In the example shown in FIG. 5D, the inputted X value and Y value are “3” and “75”, respectively. In the state where the coordinate values are inputted to the coordinate value input portion 514b, the user can select the mark point input button 514a. The mark point input button 514a is an example of an input instruction portion configured to receive a mark point input instruction. When the mark point input button 514a has been selected, the user is allowed to input mark points 523a, 523b on the image display section 520.

The mark points and the coordinate values are used for associating the lane shape indicated by the drawn lane shape line with the coordinates. That is, when the lane is curved, the mark points and the coordinate values are used for specifying a position at which the lane is curved. Therefore, two or more mark points are preferably given. When inputting the two mark points 523a, 523b, the user selects the mark point input button 514a with the first coordinate values (3, 75) being inputted to the coordinate value input portion 514b, and inputs the mark point 523a on the camera image 521. Furthermore, the user selects the mark point input button 514a with the second coordinate values (−0.5, 45) being inputted to the coordinate value input portion 514b, and inputs the mark point 523b on the camera image 521.

Refer to FIG. 4 again. The user inputs the coordinate values to the coordinate value input portion 514b, selects the mark point input button 514a, and inputs the mark points 523a, 523b on the camera image 521. The mark point input unit 415 receives the mark points 523a, 523b and the coordinate values inputted by the user. The setting screen display unit 411 displays the lane shape line 522 received by the lane shape input unit 414 and the mark points 523a, 523b received by the mark point input unit 415. The setting information transmission unit 418 transmits, to the radar 100, lane setting data indicating the lane shape line 522 and the mark points 523a, 523b. The setting information transmission unit 418 is realized by the communication I/F 407. The communication I/F 407 is an example of an output unit that outputs setting information.

The radar 100 sets the lane areas R1, R2, R3 in the coordinate space, based on the received lane setting data. FIG. 6B illustrates an example of setting of lane areas in the coordinate space of the radar. The radar 100 specifies the shape of a lane, based on the lane shape line 522 and the mark points 523a, 523b, and changes the lane areas R1, R2, R3 according to the specified shape. In the example shown in FIG. 6B, the curvature of the lane and the position at which the lane curves are specified based on the lane shape line 522 and the mark points 523a, 523b, and the lane areas R1, R2, R3 are set to be curved according to the curvature and the curve position.

Refer to FIG. 4 again. The lane editing unit 416 edits the lane areas R1, R2, R3 set in the radar 100. The lane editing unit 416 receives lane area data including the coordinate values of the lane areas R1, R2, R2, from the radar 100. The lane editing unit 416 edits the lane areas R1, R2, R3 according to an edit instruction, for the lane areas R1, R2, R3, which is given from the user.

Refer to FIG. 5A again. When the lane edit button 513b has been selected, the radar setting device 400 transmits a request for the lane area data to the radar 100. Upon receiving the request, the radar 100 transmits the lane area data to the radar setting device 400. When the radar setting device 400 has received the lane area data, the setting screen 500 shifts to the edit mode, the lane areas set in the radar 100 can be edited. FIG. 5E shows an example of the setting screen in the lane area edit mode. As shown in FIG. 5E, in the edit mode, lane shape lines 523 indicating lane marking lines of each lane are displayed so as to be superimposed on the camera image 521, and nodes 523c are displayed at a plurality of positions in the lane shape lines 523. The nodes 523c are selectable and movable points. For example, through drag-and-drop, the user can select a node 523c to be moved, and move the node 523c to a desired position. Selection and movement of the node 523c is completed when the user has released his/her finger or a stylus from the node 523c, and the corresponding lane shape line 523 is changed according to the changed position of the node 523c. This enables the user to edit the lane shape line 523 deviating from the lane marking line so that the lane shape line 523 overlaps the lane marking line.

Refer to FIG. 4 again. Based on the edited lane shape lines 523, the lane editing unit 416 generates edit data including the coordinate values that define the lane areas R1. R2, R3 after the edit, and transmits the edit data to the radar 100. The radar 100 changes the setting of the lane areas R1, R2, R3 according to the received edit data.

When the lane areas R1, R2, R3 in the coordinate space of the radar 100 have been set as described above, the radar 100 generates locus data including time-series position data of one or a plurality of vehicles V, and transmits the locus data to the radar setting device 400. The locus data reception unit 419 receives the locus data transmitted from the radar 100.

Based on the received locus data, the setting screen display unit 411 displays the travel locus of each vehicle V detected by the radar 100 so that the travel locus is superimposed on the camera image 521. FIG. 5F shows an example of the setting screen with a travel locus of a vehicle being displayed. As shown in FIG. 5F, for example, a travel locus 524 of a vehicle V may be represented by a plurality of patterns indicating the time-series positions of the vehicle. The user can determine whether or not a lane area in the coordinate space of the radar 100 is correctly set by confirming whether or not the travel locus 524 deviates from the lane. In the example shown in FIG. 5F, the travel locus 524 deviates from the lane. Therefore, the user determines that the lane area in the coordinate space of the radar 100 is not correctly set.

The lane adjustment portion 515 is used for adjusting a lane area set in the radar 100. The lane adjustment portion 515 is an example of an adjustment portion configured to receive adjustment of the position of the travel locus 524 with respect to the camera image 521. The lane adjustment portion 515 includes an enlargement button 515a, a reduction button 515b, an upward movement button 515c, a downward movement button 515d, a right movement button 515e, a left movement button 515f, a clockwise button 515g, a counterclockwise button 515h, a forward rotation button 515i, and a backward rotation button 515j.

The enlargement button 515a is a button for displaying the camera image 521 and the travel locus 524 in an enlarged manner. The reduction button 515b is a button for displaying the camera image 521 and the travel locus 524 in a reduced manner. The user selects the enlargement button 515a to display the camera image 521 and the travel locus 524 in an enlarged manner, and selects the reduction button 515b to display the camera image 521 and the travel locus 524 in a reduced manner.

The upward movement button 515c is a button for moving the travel locus 524 upward with respect to the camera image 521, and the downward movement button 515d is a button for moving the travel locus 524 downward with respect to the camera image 521. The right movement button 515e is a button for moving the travel locus 524 rightward with respect to the camera image 521, and the left movement button 515f is a button for moving the travel locus 524 leftward with respect to the camera image 521. When adjusting the position of the travel locus, the user selects the upward movement button 515c, the downward movement button 515d, the right movement button 515e, or the left movement button 515f.

The clockwise button 515g is a button for rotating the travel locus 524 clockwise with respect to the camera image 521, and the counterclockwise button 515h is a button for rotating the travel locus 524 counterclockwise with respect to the camera image 521. The forward rotation button 515i is a button for rotating the travel locus 524 forward in the depth direction of the screen, and the backward rotation button 515j is a button for rotating the travel locus 524 backward in the depth direction of the screen. When adjusting the angle of the travel locus, the user selects the clockwise button 515g, the counterclockwise button 515h, the forward rotation button 515i, or the backward rotation button 515j. The user adjusts the position and angle of the travel locus 524 so that the travel locus 524 correctly fits in the lane.

FIG. 5G shows an example of the setting screen after the position and angle of the travel locus 524 are adjusted. When the enlargement button 515a, the reduction button 515b, the upward movement button 515c, the downward movement button 515d, the right movement button 515e, the left movement button 515f, the clockwise button 515g, the counterclockwise button 515h, the forward rotation button 515i, or the backward rotation button 515j has been operated to instruct adjustment of the position and angle of the travel locus 524, the position and angle of the travel locus 524 displayed on the setting screen 400 are changed according to the instruction as shown in FIG. 5G. Thus, the user can easily determine whether or not the travel locus 524 correctly fits in the lane by confirming the travel locus 524 superimposed and displayed on the image 521.

Refer to FIG. 4 again. The coordinate adjustment unit 417 receives the direction and amount of adjustment, for the coordinates of the travel locus 524, which are inputted through the enlargement button 515a, the reduction button 515b, the upward movement button 515c, the downward movement button 515d, the right movement button 515e, the left movement button 515f, the clockwise button 515g, the counterclockwise button 515h, the forward rotation button 515i, or the backward rotation button 515j. The setting screen display unit 411 changes the position and angle of the travel locus 524 in the setting screen 500, according to the direction and amount of adjustment, for the coordinates of the travel locus 524, which are received by the coordinate adjustment unit 417. Correction data is generated based on the direction and amount of adjustment, for the coordinates of the travel locus 524, which are received by the coordinate adjustment unit 417. The correction data is information (correction information) for correcting the position and shape of a lane in the coordinate space of the radar 100, based on the adjustment of the position of the travel locus 524. The setting information transmission unit 418 transmits the generated correction data to the radar 100. Based on the received correction data, the radar 100 adjusts the lane areas R1, R2, R3 in the coordinate space. The setting information transmission unit 418 is realized by the communication I/F 407 as described above. The communication I/F 407 is an example of an output unit that outputs correction data.

The radar setting device 400 has a function of confirming the detection accuracy of the radar 100 after the lane area setting of the radar 100 as described above is performed. This function is provided by the first count result input unit 420, the second count result input unit 421, the radar detection result reception unit 422, the collation unit 423, and the setting screen display unit 411.

After completing the lane area setting, the radar 100 transmits traffic count data indicating the number of vehicles detected for each lane. The radar 10 counts the number of vehicles in each lane for each predetermined detection period, and transmits the traffic count data. The first count result input unit 420 receives the traffic count data transmitted from the radar 100. The setting screen display unit 411 displays the number of vehicles detected for each lane, based on the received traffic count data.

The second count result input unit 421 receives the number of vehicles for each lane, which is inputted by the user during the detection period. The setting screen display unit 411 displays the number of vehicles for each lane, inputted by the user.

Refer to FIG. 5A again. The setting screen 500 also serves as a confirmation screen for confirming the detection accuracy of the radar 100. The traffic count result display section 530 includes a first count result display portion 531 and a second count result display portion 532. The first count result display portion 531 is an area for displaying the number of vehicles for each lane counted by the radar 100. The first count result display portion 531 is an example of a first result display portion. The first count result display portion 531 includes: a count value display portion 531a for displaying the number of vehicles in the first lane; a count value display portion 531b for displaying the number of vehicles in the second lane; a count value display portion 531c for displaying the number of vehicles in the third lane; and a count value display portion 531d for displaying the number of vehicles in the fourth lane.

The second count result display portion 532 includes: count buttons 532a, 533a for counting the number of vehicles traveling on the first lane and a count value display portion 534a for displaying the count value of the first lane; count buttons 532b. 533b for counting the number of vehicles on the second lane and a count value display portion 534b for displaying the count value of the second lane; count buttons 532c, 533c for counting the number of vehicles on the third lane and a count value display portion 534c for displaying the count value of the third lane; and count buttons 532d, 533d for counting the number of vehicles on the fourth lane and a count value display portion 534d for displaying the count value of the fourth lane. The second count result display portion 532 is an example of a second result display portion. The count value display portion 534a displays a numerical value according to the number of times the count buttons 532a, 533a are selected. The count value display portion 534b displays a numerical value according to the number of times the count buttons 532b, 533b are selected. The count value display portion 534c displays a numerical value according to the number of times the count buttons 532c, 533c are selected. The count value display portion 534d displays a numerical value according to the number of times the count buttons 532d, 533d are selected. Each of the count buttons 532a, 532b, 532c, 532d is a button for incrementing the count value, and each of the count buttons 533a, 533b, 533c, 533d is a button for decrementing the count value. The second count result display portion 532 is an example of a second result display portion, and the count value of the number of vehicles for each lane is an example of reference information.

Furthermore, the traffic count result display section 530 includes a detection period display portion 535. The detection period display portion 535 includes: a reception time display portion 535a for displaying a time at which traffic count data from the radar 100 was received last time; a reception schedule display portion 535b for displaying a scheduled time at which traffic count data from the radar 100 will be received next time, and a reception interval display portion 535c for displaying a reception interval of traffic count data.

FIG. 5H shows an example of the setting screen on which the number of vehicles for each lane based on the traffic count data, and the number of vehicles for each lane inputted by the user, are displayed. In the example shown in FIG. 5H, the numbers of vehicles on the first lane, the second lane, and the third lane, which are detected by the radar 100, are “14”, “25”, and “7”, respectively, while the numbers of vehicles on the first lane, the second lane, and the third lane, which are counted by the user, are “13”, “25”, and “7”, respectively. “14” is displayed in the count value display portion 531a, “25” is displayed in the count value display portion 531b, and “7” is displayed in the count value display portion 531c. “13” is displayed in the count value display portion 534a. “25” is displayed in the count value display portion 534b, and “7” is displayed in the count value display portion 534c. The count value display portion of the radar 100 and the count value display portion of the user, of the same lane, are vertically aligned. That is, the count value display portions 531a and 534a of the first lane are vertically aligned, the count value display portions 531b and 534b of the second lane are vertically aligned, the count value display portions 531c and 534c of the third lane are vertically aligned, and the count value display portions 531d and 534d of the fourth lane are vertically aligned. This allows the count value by the radar and the count value by the user to be easily compared.

In the reception time display portion 535a, the reception time “2021/4/1 15:00:00” of the previous traffic count data is displayed. In the reception schedule display portion 535b, the scheduled reception time “2021/4/1 15:02:30” of the next traffic count data is displayed. In the reception interval display portion 535c, the reception interval “2.5 min” of the traffic count data is displayed. In the present embodiment, the reception time and the reception interval of the traffic count data constitute the detection period. For example, if the count value of the number of vehicles for each lane detected by the radar 100 is sufficiently approximated to the count value of the number of vehicles for each lane visually counted by the user, the detection period (the reception time and the reception interval of the previous traffic count data) are displayed together with the count value of the number of vehicles for each lane detected by the radar 100 and the count value of the number of vehicles for each lane visually counted by the user, whereby the user can confirm that the detection accuracy of the radar 100 is ensured in the detection period. For example, the screen shown in FIG. 5H being logged allows the user to confirm afterwards that the detection accuracy of the radar 100 is ensured during the detection period.

For example, unused count value display portions may indicate that they are disabled. In the example shown in FIG. 5H, since the number of lanes in the target area 300 is 3, the count value display portions 531d and 534d for the fourth lane are not used. Therefore, the color of the count value display portions 531d and 534d is gray indicating that these portions are disabled. Moreover, unused count buttons may indicate that they are disabled. In the example shown in FIG. 5H, the color of the unused count buttons 532d and 533d is gray.

The traffic count result display section 530 further includes a delete button 536 for deleting the count values displayed in the count value display portions 531a. 531b, 531c, 531d, 534a, 534b, 534c, 534d. When deleting a count value, the user can delete the count value by selecting the delete button 536.

Refer to FIG. 4 again. The radar 100 transmits detection result data indicating a detection result. The detection result includes position information of a detected vehicle V. The radar detection result reception unit 422 receives the detection result data transmitted from the radar 100. The setting screen display unit 411 displays the position of the vehicle V included in the detection result data.

Refer to FIG. 5H again. The bird's eye view display section 540 displays a bird's eye view of the target area 300 on which the positions of vehicles V detected by the radar 100 are superimposed. As shown in FIG. 5H, in the bird's eye view display section 540, a bird's eye view 541 of the lanes included in the target area 300, and patterns 542 indicating the positions of the vehicles V detected in the respective lanes, are displayed. The radar 100 transmits the detection result data in a predetermined cycle, and the positions of the patterns 542 in the bird's eye view display section 540 are updated according to the detection result data received in the radar setting device 400. Thus, the positions of the vehicles V in real time are displayed in the bird's eye view display section 540. The user can confirm that the detection accuracy of the radar 100 is satisfactory by comparing the positions of the vehicles V in the bird's eye view display section 540 with the camera image 521 in the image display section 520, for example.

Refer to FIG. 4 again. The collation unit 423 collates the number of vehicles detected by the radar 100 during the detection period with the number of vehicles traveling in the target area 300 and counted by the user during the detection period. Specifically, the collation unit 423 collates the count value of the number of vehicles for each lane indicated by the traffic count data, with the count value of the number of vehicles for each lane inputted by the user. The collation unit 423 calculates the accuracy of the count value of the number of vehicles detected by the radar 100, with the count value of the number of vehicles inputted by the user being a true value. In the example of FIG. 5H, the count value of the number of vehicles on the first lane detected by the radar 100 is “14”, the count value of the number of vehicles on the first lane inputted by the user is “13”, and the accuracy of the count value of the number of vehicles on the first lane detected by the radar 100 is 92.9%. The count value of the number of vehicles on the second lane detected by the radar 100 is “25”, the count value of the number of vehicles on the second lane inputted by the user is “25”, and the accuracy of the count value of the number of vehicles on the second lane detected by the radar 100 is 100%. The count value of the number of vehicles on the third lane detected by the radar 100 is “7”, the count value of the number of vehicles on the third lane inputted by the user is “7”, and the accuracy of the count value of the number of vehicles on the third lane detected by the radar 100 is 100%. When a plurality of lanes are included in the target area 300, the collation unit 423 calculates, for example, an average value of the accuracies of the lanes, as the accuracy of the detection result of the radar 100. In the example shown in FIG. 5H, the accuracy is 97.6%.

The collation unit 423 can determine whether the detection accuracy is acceptable or unacceptable by comparing the calculated accuracy with a predetermined reference value. In the present embodiment, the reference value is 95%. In the example shown in FIG. 5H, the collation unit 423 determines that the detection accuracy is acceptable. The setting screen display unit 411 displays at least one of: the accuracy calculated by the collation unit 423; and the determination result as to whether or not the detection accuracy is acceptable.

Refer to FIG. 5H again. When the collation unit 423 has collated the number of vehicles detected by the radar 100 during the detection period, with the number of vehicles traveling in the target area 300 and counted by the user during the detection period, a collation result is displayed on a collation result display section 550. The collation result display section 550 is an area for displaying the collation result of the collation unit 423. The collation result display section 550 includes, for example, an accuracy display portion 550a for displaying the accuracy of the detection result of the radar 100, and a determination result display portion 550b for displaying a determination result as to whether or not the detection accuracy of the radar 100 is acceptable. If the determination result is acceptable, for example, the characters “success” are displayed on the determination result display portion 550b. If the determination result is unacceptable, for example, the characters “unsuccess” are displayed on the determination result display portion 550b. Confirming the collation result display section 550 allows the user to grasp the detection accuracy of the radar 100 and whether or not the detection accuracy is equal to or higher than the predetermined reference.

Refer to FIG. 4 again. The log saving unit 424 logs a process of confirming the detection accuracy of the radar 100 (hereinafter, referred to as “detection accuracy confirmation process”), and saves the logged detection accuracy confirmation process. The detection accuracy confirmation process includes: receiving traffic count data from the radar 100 by the first count result input unit 420; receiving, by the second count result input unit 421, an input of the number of vehicles for each lane by the user; receiving detection result data from the radar 100 by the radar detection result reception unit 422; and collating the number of vehicles for each lane by the collation unit 423. The log of the detection accuracy confirmation process is, for example, a moving image of the setting screen 500 during a period from start of the detection period to display of the collation result of the number of vehicles (hereinafter, referred to as “logging period”). The moving image of the setting screen 500 includes a moving image of the target area 300 in the screen display unit 521. Instead of the moving image, a plurality of still images of the setting screen 500 at a plurality of time points in the logging period may be used as the log of the detection accuracy confirmation process. In the following description, the log of the detection accuracy confirmation process is the moving image of the setting screen 500.

Refer to FIG. 5A again. The collation result display section 550 includes a log start button 551. The log start button 551 is a button for instructing the start of logging of the detection accuracy confirmation process. When the user has selected the log start button 551, logging of the moving image of the setting screen 500 is started, and a detection period start instruction is transmitted to the radar 100. Upon receiving the detection period start instruction, the radar 100 starts the detection period. Furthermore, as described above, the radar 100 detects the number of vehicles for each lane, and transmits traffic count data. When the user has selected the log start button 551, the user inputs the number of vehicles for each lane into the radar setting device 400 as described above. The inputted count values are displayed on the count value display portions 531a, 531b. 531c, 531d, 534a, 534b, 534c, and 534d. The radar 100 detects the positions of vehicles V in the target area 300, and transmits detection result data. The positions of the vehicles V detected by the radar 100 are displayed so as to be superimposed on the bird's eye view of the target area 300 in the bird's eye view display section 540. When the detection period has ended, the collation unit 423 collates the number of vehicles detected by the radar 100 during the detection period, with the number of vehicles that are traveling in the target area 300 and are counted by the user during the detection period. The collation unit 423 calculates the accuracy of the count value of the number of vehicles by the radar 100, and the calculated accuracy and the determination result as to whether or not the detection accuracy of the radar 100 is acceptable, are displayed on the collation result display section 550. Then, logging of the moving image of the setting screen 500 is stopped to end the logging period.

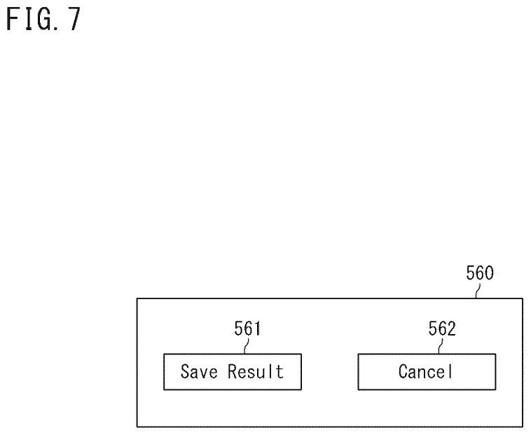

Refer to FIG. 4 again. When logging of the detection accuracy confirmation process is stopped, the log saving unit 424 saves the logged detection accuracy confirmation process. For example, the log saving unit 424 performs saving of the log of the detection accuracy confirmation process, according to an instruction of the user. When logging of the detection accuracy confirmation process is stopped (i.e., when the logging period has ended), a save instruction section, which is a window for the user to instruct saving of the log of the detection accuracy confirmation process, may be displayed. FIG. 7 shows an example of the save instruction section. A save instruction section 560 includes a save instruction button 561, and a cancel button 562. The save instruction button 561 is a button for instructing saving of the log of the detection accuracy confirmation process, and the cancel button 562 is a button for discarding the log of the detection accuracy confirmation process. When the save instruction button 561 is selected by the user, the log of the detection accuracy confirmation process (moving image data) is saved in the non-volatile memory 402, for example. The log may be saved in an internal memory of the radar 100, or may be saved in an external server connected to the radar setting device 400 via the network. When the cancel button 562 is selected by the user, the log of the detection accuracy confirmation process is discarded. When one of the save instruction button 561 and the cancel button 562 is selected, the save instruction section 560 is closed.

The save instruction section 560 is an example of the configuration for the user to instruct saving of the log of the detection accuracy confirmation process, and the configuration is not limited thereto. For example, the collation result display section 550 on the setting screen 500 may be provided with a button for instructing saving of the log of the detection accuracy confirmation process, and the user may select this button to instruct saving of the log of the detection accuracy confirmation process.

The saved log of the detection accuracy confirmation process enables the user to confirm afterwards the detection accuracy of the radar 100 during the detection period, and the determination result as to whether or not the detection accuracy is acceptable. Furthermore, the entire detection accuracy confirmation process being logged can be used as evidence that the detection accuracy of the radar 100 and the acceptable/unacceptable determination result are obtained through the appropriate processes, thereby inhibiting forgery and falsification of the detection accuracy of the radar 100 and the acceptable/unacceptable determination result.

### [1-4. Operation of Radar Setting Device]

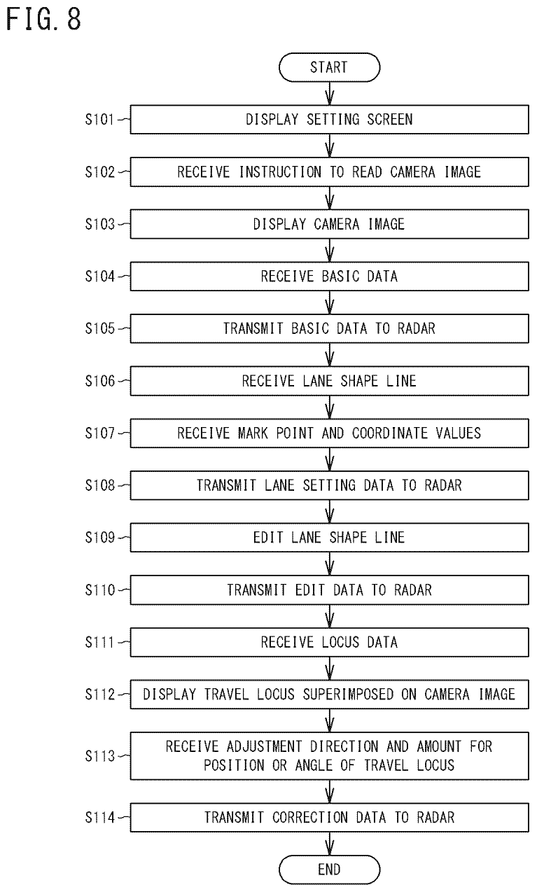

FIG. 8 is a flowchart showing an example of a procedure of a lane area setting process by the radar setting device 400 according to the first embodiment. When the processor 401 has started the setting program 409, the radar setting device 400 performs a lane area setting process as follows.

The processor 401 causes the display unit 405 to display the setting screen 500 for lane area setting of the radar 100 (step S101).

The user selects the image read button 511a (see FIG. 5A), and instructs the radar setting device 400 to read the camera image 521. The processor 401 receives the instruction to read the camera image 521 (step S102). Upon receiving the read instruction, the processor 401 reads the camera image 521 and causes the image display section 520 to display the read camera image 521 (step S103).

The user inputs basic data to the basic data input portion 512 (see FIG. 5A). The processor 401 receives the inputted basic data (step S104). The processor 401 transmits the inputted basic data to the radar 100 (step S105). The radar 100 performs initial setting of a coordinate system and lane areas in a coordinate space by using the basic data.

The user selects the lane drawing instruction button 513a, and draws the lane shape line 522 on the camera image 521 (see FIG. 5A). The processor 401 receives an input of the lane shape line 522 (step S106).

The user inputs coordinate values to the coordinate value input portion 514b, selects the mark point input button 514a, and inputs the mark points 523a, 523b on the camera image 521 (see FIG. 5A). The processor 401 receives an input of the mark points 523a, 523b and the coordinate values (step S107).

The processor 401 generates lane setting data, based on data of the received lane shape line 522 and data of the mark points 523a. 523b and coordinate value, and transmits the lane setting data to the radar 100 (step S108). Based on the received lane setting data, the radar 100 specifies the lane shape, and changes the lane areas according to the specified shape.

The user selects the lane edit button 513b (see FIG. 5A). Upon receiving the selection of the lane edit button 513b, the processor 401 requests lane area data from the radar 100. In response to the request, the radar 100 transmits the lane area data including the coordinate values of the lane areas R1, R2, R3. Upon receiving the lane area data, the processor 401 displays the lane shape lines 523 indicating the lane marking lines of the respective lanes, based on the lane areas R1, R2, R3, so that the lane shape lines 523 are superimposed on the camera image 521. The user edits a lane shape line 523 by moving a node 523c in the lane shape line 523 (step S109). The processor 401 generates edit data that defines the lane areas R1, R2, R3 after the edit, according to the edited lane shape line 523, and transmits the edit data to the radar 100 (step 110). The radar 100 changes the setting of the lane areas R1, R2, R3, according to the edit data.

The radar 100 generates locus data from time-series position data of a detected vehicle V, and transmits the locus data to the radar setting device 400. The radar setting device 400 receives the locus data (step S111). Based on the received locus data, the processor 401 displays the travel locus 524 (see FIG. 5F) of the vehicle V superimposed on the camera image 521 (step S112).

The user adjusts the position or the angle of the travel locus 524 so that the travel locus 524 fits in the lane in the camera image 521, by using at least one of the enlargement button 515a, the reduction button 515b, the upward movement button 515c, the downward movement button 515d, the right movement button 515e, the left movement button 515f, the clockwise button 515g, the counterclockwise button 515h, the forward rotation button 515i, and the backward rotation button 515j which are included in the lane adjustment portion 515. The processor 401 receives the direction and amount of adjustment for the position or the angle of the travel locus 524 (step S113).

The processor 401 generates correction data from the received direction and amount of adjustment for the coordinates of the travel locus 524, and transmits the correction data to the radar 100 (step S114). Based on the received correction data, the radar 100 adjusts the position and angle of the corresponding lane area in the coordinate space. This is the end of the lane area setting process.

### 2. Second Embodiment

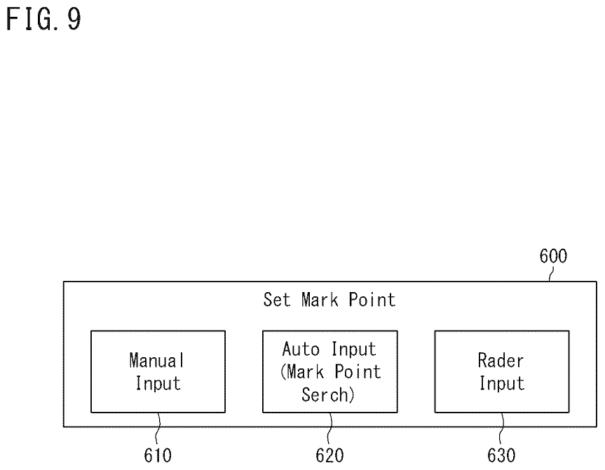

In this embodiment, the user can select a mark point inputting method. Refer to FIG. 5A. In the present embodiment, the mark point input button 514a is a button for selecting a mark point inputting method. When the mark point input button 514a is selected by the user, a selection section that is a window for selecting a mark point is displayed. FIG. 9 shows an example of the selection section. A selection section 600 includes a manual input button 610, an automatic input button 620, and a radar input button 630.

The manual input button 610 is a button for selecting a user's manual input, as a mark point inputting method. When the manual input button 610 is selected by the user, as in the first embodiment, the user is allowed to input mark points 523a, 523b in the image display section 520.

The automatic input button 620 is a button for selecting automatic input of mark points through an image recognition process, as a mark point inputting method. When the automatic input button 620 is selected by the user, the processor 401 performs the image recognition process on the camera image 521, and recognizes the components of the road, e.g., lane marking lines, road markings (crosswalks, stop lines, regulatory markings, etc.), road signs, etc. The processor 401 sets a feature point of a recognized component (e.g., an end point of a white line) as a mark point. Thus, the mark point is automatically inputted.

A feature point recognized from the camera image 521 may be used as a candidate point for the mark point. Preferably, there are a plurality of candidate points. In the image display section 520, candidate points are displayed so as to be superimposed on the camera image 521. Each candidate point is selectable through the input unit 406, and a selected candidate point is set as a mark point. The user inputs a mark point by selecting a candidate point.

The radar input button 630 is a button for selecting an input of a mark point detected by the radar 100, as a mark point inputting method. When the radar input button 630 is selected by the user, an object disposed near the road, e.g., a road sign, a marker disposed on the roadside or on the road, etc., is detected by the radar 100. The radar 100 transmits, to the radar setting device 400, mark point data including position information of the detected object. When the mark point data is received by the radar setting device 400, the mark point is inputted.

As described above, the mark point inputted through the selected inputting method is displayed so as to be superimposed on the camera image 521. The user inputs the coordinate values of the mark point to the coordinate value input portion 514b. Thus, the mark point and the coordinate values are given to the radar setting device 400.

### 3. Effects of Embodiments

The radar setting device (display device) 400 according to the embodiments includes the display unit 405 and the input unit 406. The display unit 405 is configured to display the setting screen 500 for setting the radar 100. The radar 100 is a radio wave radar, for infrastructure, which transmits a radio wave to the target area 300, and detects a vehicle V in the target area 300 by receiving the wave reflected by the vehicle V. The input unit 406 is configured to receive an input of the lane shape line 522 and the mark points 523a, 523b. The lane shape line 522 indicates the shape of a lane in the target area 300. The mark points 523a, 523b indicate specific positions in the target area 300. The setting screen 500 includes the image display section 520, and the coordinate value input portion (coordinate value display section) 514b. The image display section 520 is configured to display the lane shape line 522 and the mark points 523a, 523b, which are inputted through the input unit 406, so that they are superimposed on the camera image 521 which is obtained by the camera 107 that captures the image of the target area 300. The coordinate value input portion 514b is configured to display the coordinate values corresponding to the specific positions. The coordinate values indicate the position, in the coordinate space, of an object detected by the radar 100. Thus, the user can input, to the setting screen 500, the lane shape line 522 and the mark points 523a, 523b which are used for defining the relationship between the coordinate space of the radar 100 and the position of the road, thereby supporting setting of the relationship between the coordinate space and the position of the road in the radar.

The radar setting device 400 may further include the communication I/F (output unit) 407. The communication I/F 407 is configured to set the position and shape of a lane in the coordinate space, based on the lane shape line 522, the mark points 523a. 523b, and the coordinate values received by the input unit 406. Thus, the position and shape of the lane in the coordinate space of the radar 100 can be set by using the outputted setting information.

The setting screen 500 may further include the mark point input button (input instruction portion) 514a. The mark point input button 514a is configured to receive an instruction to input the mark points 523a, 523b. When the instruction to input the mark points 523a. 523b is received by the mark point input button 514a, the radar setting device 400 may allow input of the mark point 52 on the camera image 521. After instructing input of the mark points 523a, 523b through the mark point input button 514a, the user can input the mark points 523a, 523b directly on the camera image 521. Thus, input of the mark points 523a, 523b by the user can be supported.

The coordinate value input portion 514b may receive the coordinate values inputted through the input unit 406, and display the received coordinate values. Thus, input of the coordinate values of the mark points 523a, 523b in the coordinate space of the radar 100 can be supported.

The image display section 520 may display, on the camera image 521, selectable candidate points that are candidates for the mark points 523a, 523b. Candidate points selected through the input unit 406 may be the mark points 523a, 523b. Thus, the user can easily input the mark points 523a. 523b by selecting the candidate points. As a result, input of the mark points 523a, 523b by the user can be supported.

The image display section 520 may display the travel locus 524 of a vehicle V detected by the radar 100 so that the travel locus 524 is superimposed on the camera image 521. By confirming whether or not the travel locus 524 fits in a lane in the camera image 521, the user can easily confirm whether or not the relationship between the coordinate space of the radar 100 and the position of the lane is accurately set.

The setting screen 500 may further include the lane adjustment portion (adjustment portion) 515. The lane adjustment portion 515 is configured to receive adjustment of the position of the travel locus 524 with respect to the camera image 521. The radar setting device 400 may include the communication I/F (output unit) 407. The communication I/F 407 is configured to output the correction data (correction information), based on adjustment of the position of the travel locus 524. The correction data is information for correcting the position and shape of a lane in the coordinate space. Thus, the relationship between the coordinate space and the lane position can be corrected by adjusting the position of the travel locus 524 in the camera image 521.

Based on adjustment of the position of the travel locus 524, the position of the travel locus 524 with respect to the camera image 521 may be changed. Thus, the user can adjust the position of the travel locus 524 while confirming the position of the travel locus 524 with respect to the camera image 521. Therefore, adjustment of the position of the travel locus 524 by the user can be supported.

The radar 100 may include the fixing member 107a. The fixing member 107a fixes the camera 107 in the state where the optical axis direction of the camera 107 is aligned with the axial direction of the radio wave irradiation axis of the radar 100. Thus, when the radio wave irradiation axis of the radar 100 is aligned to the target area 300, the camera 107 can capture the image of the target area 300.

### 4. Supplementary Note

The above embodiments are merely illustrative in all aspects and are not restrictive. The scope of the present disclosure is defined by the scope of the claims rather than the embodiments described above, and is intended to include meaning equivalent to the scope of the claims and all modifications within the scope.

### REFERENCE SIGNS LIST

100 radar (radio wave radar for infrastructure)
101 transmission/reception surface
102 radar body
103 depression angle adjustment member
104 horizontal angle adjustment member
105 roll angle adjustment member
106 storage part
107 camera
107a fixing member
200 arm
300 target area
400 radar setting device (display device)
401 processor
402 non-volatile memory
403 volatile memory
404 graphic controller
405 display unit
406 input unit
409 setting program
411 setting screen display unit
412 image input unit
413 data input unit
414 lane shape input unit
415 mark point input unit
416 lane editing unit
417 coordinate adjustment unit
418 setting information transmission unit
419 locus data reception unit
420 first count result input unit
421 second count result input unit
422 radar detection result reception unit
423 collation unit
424 log saving unit
500 setting screen (confirmation screen)
510 user operation section
511 image reading instruction portion
511a image read button
512 basic data input portion
512a number-of-lanes input portion
512b lane width input portion
512c installation height input portion
512d offset amount input portion
512e detection method input portion
513 lane drawing instruction portion
513a lane drawing instruction button
513b lane edit button
514 mark point input instruction portion
514a mark point input button
514b coordinate value input portion
515 lane adjustment portion
515a enlargement button
515b reduction button
515c upward movement button
515d downward movement button
515e right movement button
515f left movement button
515g clockwise button
515h counterclockwise button
515i forward rotation button
515j backward rotation button
520 image display section
521 camera image
522, 523 lane shape line
523a, 523b mark point
523c node
524 travel locus
530 traffic count result display section
531 first count result display portion (first result display portion)
531a, 531b, 531c, 531d, 534a, 534b, 534c, 534d count value display portion
532 second count result display portion (second result display portion)
532a, 533a, 532b, 533b, 532c, 533c, 532d, 533d count button
535 detection period display portion
535a reception time display portion
535b reception schedule display portion
535c reception interval display portion
536 delete button
540 bird's eye view display section
541 bird's eye view
542 pattern
550 collation result display section
550a accuracy display portion
550b determination result display portion
551 log start button
560 save instruction section
561 save instruction button
562 cancel button
600 selection section
610 manual input button
620 automatic input button
630 radar input button
R1, R2, R3 lane area
V vehicle

1. A display device comprising:
a display configured to display a setting screen for setting a radio wave radar for infrastructure, the radio wave radar being configured to transmit a radio wave to a target area, and receive a reflected wave from a vehicle to detect the vehicle in the target area; and
an interface configured to receive an input of a lane shape line indicating a shape of a lane in the target area, and an input of a mark point indicating a specific position in the target area, wherein
the setting screen includes circuitry configured to
display the lane shape line and the mark point inputted through the interface so that the lane shape line and the mark point are superimposed on an image obtained by a camera that images the target area, and
display coordinate values corresponding to the mark point, and
the coordinate values are coordinate values, in a coordinate space, which indicate a position of an object detected by the radio wave radar for infrastructure.

2. The display device according to claim 1, further comprising an output interface configured to output setting information for setting a position and a shape of a lane in the coordinate space, based on the lane shape line and the mark point received through the interface and on the coordinate values.

3. The display device according to claim 1, wherein
the setting screen further includes an input instruction interface configured to receive an instruction to input the mark point, and
under a condition the instruction to input the mark point has been received by the input instruction interface, input of the mark point on the image is allowed.

4. The display device according to claim 1, wherein
the circuitry receives the coordinate values inputted through the interface, and displays the received coordinate values.

5. The display device according to claim 1, wherein
the display displays, on the image, selectable candidate points that are candidates for the mark point, and
a candidate point selected through the interface is set as the mark point.

6. The display device according to claim 1, wherein
the display displays a movement locus of the object detected by the radio wave radar for infrastructure so that the movement locus is superimposed on the image.

7. The display device according to claim 6, wherein
the setting screen further includes an adjustment portion configured to receive adjustment of the position of the movement locus with respect to the image, and
the display device includes an output interface configured to, based on the adjustment of the position of the movement locus, output correction information for correcting the position and the shape of the lane in the coordinate space.

8. The display device according to claim 7, wherein
the position of the movement locus is changed with respect to the image, based on the adjustment of the position of the movement locus.

9. The display device according to claim 1, wherein
the radio wave radar for infrastructure includes a fixing member that fixes the camera, with an optical axis direction of the camera being aligned with an axial direction of a radio wave irradiation axis of the radio wave radar for infrastructure.

10. A non-transitory computer readable storage medium storing a computer program for causing a computer to perform the steps of:
displaying a setting screen for setting a radio wave radar for infrastructure, the radio wave radar being configured to transmit a radio wave to a target area, and receive a reflected wave from a vehicle to detect the vehicle in the target area; and
receiving an input of a lane shape line indicating a shape of a lane in the target area, and an input of a mark point indicating a specific position in the target area, wherein
the setting screen includes
displaying the lane shape line and the mark point inputted through an interface so that the lane shape line and the mark point are superimposed on an image obtained by a camera that images the target area, and
displaying coordinate values corresponding to the mark point, and
the coordinate values are coordinate values, in a coordinate space, which indicate a position of an object detected by the radio wave radar for infrastructure.

11. A setting method using, in combination, a radio wave radar for infrastructure, and a camera, the radio wave radar being configured to transmit a radio wave to a target area and receive a reflected wave from a vehicle to detect the vehicle in the target area, the camera being configured to enable optical expression of a field of view of the radio wave radar for infrastructure,
the method comprising:
determining a mark point that indicates a specific position included in the target area;
displaying the mark point and a lane shape line that indicates a shape of a lane included in the target area so that the mark point and the lane shape line are superimposed on an image obtained by the camera; and
setting coordinates indicating the position of the mark point.
